(19) United States
(12) Patent Application Publication
(10) Pub. No.: US 2005/0095006 A1
(43) Pub. Date: May 5, 2005

(54) Cable station for an undersea optical transmission system

(75) Inventors: Stephen G. Evangelides JR., Red Bank, NJ (US); Jay P. Morreale, Summit, NJ (US); Michael J. Neubelt, Little Silver, NJ (US); Mark K. Young, Monmouth Junction, NJ (US); Jonathan A. Nagel, Brooklyn, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Red Sky Systems, Inc.

(21) Appl. No.: 10/699,604

(22) Filed: Oct. 31, 2003

(51) Int. Cl. H04B 10/00

(52) U.S. Cl. 398/158

(57) ABSTRACT

In accordance with the present invention, a land-based cable station is provided for an undersea optical transmission system. The cable station includes submarine line terminal equipment (SLTE) for processing terrestrial traffic received from an external source, power feed equipment for supplying electrical power to active undersea components of the transmission system, an element management system for configuring and obtaining status information from the transmission system, and a cable termination box in which an undersea cable terminates. The SLTE includes terrestrial optical transmission equipment receiving the terrestrial traffic and generating optical signals in response thereto. The SLTE also includes an interface device providing signal conditioning to the optical signals received from the terrestrial optical transmission equipment so that the optical signals are suitable for transmission through the undersea optical transmission system.

### FIELD OF THE INVENTION

The present invention relates generally to undersea optical transmission systems, and more particularly to a cable station for an optical transmission system to which electrical power is supplied such as an undersea optical transmission system.

### BACKGROUND OF THE INVENTION

An undersea optical transmission system consists of land-based cable stations interconnected by a cable that is installed on the ocean floor. The cable contains optical fibers that carry Dense Wavelength Division Multiplexed (DWDM) optical signals between the terminals. The cable stations contain power supplies for the undersea cable, transmission equipment to insert and remove DWDM signals from the fibers and associated monitoring and control equipment. Over long distances the strength and quality of a transmitted optical signal diminishes. Accordingly, repeaters are located along the cable, which contain optical amplifiers to provide amplification to the optical signals to overcome fiber loss.

A functional block diagram of a conventional cable station is shown in FIG. 1. The cable station 10 includes submarine line terminal equipment (SLTE) 12, power feed equipment (PFE) 18, and an element management system (EMS) 16 and a cable termination box (CTB) 14. The SLTE 12 converts terrestrial traffic into an optical signal that is appropriate for an undersea transmission line. The power-feed equipment 18 that electrically powers all the active undersea equipment, most notably the repeaters. The EMS 16 allows the system operator to configure the system and to obtain information regarding its status. The CTB 14 terminates the undersea cable and physically separates the cable into optical fibers and the power-feed line and may also serve as a monitoring point for the cable. Additional details concerning cable stations may be found in chapter 10 of “Undersea Fiber Communication Systems,” J. Chesnoy, ed. (Academic Press, 2002).

On the transmit side, the SLTE 12 receives traffic such as an STM signal from a terrestrial terminal that is generally located in a Point of Presence (PoP). The SLTE 12 converts each wavelength of the optical signal to an electrical signal and encodes it with FEC. An electrical to optical unit modulates a continuous wave light from a laser with the electrical signal to generate an optical line signal at each wavelength, which is then optically amplified. The amplified wavelengths may undergo signal conditioning such as dispersion compensation before (or after) being multiplexed together and sent out on the undersea transmission cable. The receive side of the SLTE 12 operates in a complementary manner. The SLTE 12 may also performing line monitoring to determine the status and health of the transmission path. For example, the SLTE 12 may employ a COTDR arrangement to monitor and measure the optical loss of the transmission line.

One type of highly specialized optical transmission network is undersea or submarine optical transmission systems in which a cable containing optical fibers is installed on the ocean floor. The design of cable stations, as well as the design of undersea optical transmission systems generally, are typically customized on a system-by-system basis and employ highly specialized terminals to transmit data over the undersea optical transmission path. Since the specialized terminals are produced in small volumes they are relatively expensive in comparison to optical transmission terminals designed for terrestrial optical networks, which are typically produced in relatively high volume for terrestrial optical transmission networks. Moreover, the amount of equipment that can be located in the cable station is limited because of the relatively small dimensions of most cable stations.

Accordingly, it would be desirable to provide a cable station for an undersea optical transmission system that is more economical while potentially reducing the amount of space it occupies.

### SUMMARY OF THE INVENTION

In accordance with the present invention, a land-based cable station is provided for an undersea optical transmission system. The cable station includes submarine line terminal equipment (SLTE) for processing terrestrial traffic received from an external source, power feed equipment for supplying electrical power to active undersea components of the transmission system, an element management system for configuring and obtaining status information from the transmission system, and a cable termination box in which an undersea cable terminates. The SLTE includes terrestrial optical transmission equipment receiving the terrestrial traffic and generating optical signals in response thereto. The SLTE also includes an interface device providing signal conditioning to the optical signals received from the terrestrial optical transmission equipment so that the optical signals are suitable for transmission through the undersea optical transmission system.

In accordance with one aspect of the invention, the terrestrial optical equipment is a SONET/SDH terminal.

In accordance with another aspect of the invention, the terrestrial optical terminal is an ATM terminal.

In accordance with another aspect of the invention, the terrestrial optical terminal is a Gigabit Ethernet terminal.

In accordance with another aspect of the invention, the undersea optical transmission system is a WDM transmission system.

In accordance with another aspect of the invention, the interface device is configured to perform at least one signal conditioning process selected from the group consisting of gain equalization, bulk dispersion compensation, optical amplification, Raman amplification, dispersion slope compensation, PMD compensation, load balancing, and performance monitoring.

In accordance with another aspect of the invention, the external source from which the terrestrial traffic is received is a terrestrial point-of-presence.

In accordance with another aspect of the invention, the interface device includes line monitoring equipment.

In accordance with another aspect of the invention, the line monitoring equipment is a COTDR arrangement.

In accordance with another aspect of the invention, the interface device includes an arrangement for supplying pump power to impart Raman amplification to the optical signals.

### BRIEF DESCRIPTION OF THE DRAWINGS

FIG. 1 shows a functional block diagram of a conventional cable station employed in an undersea optical transmission system.

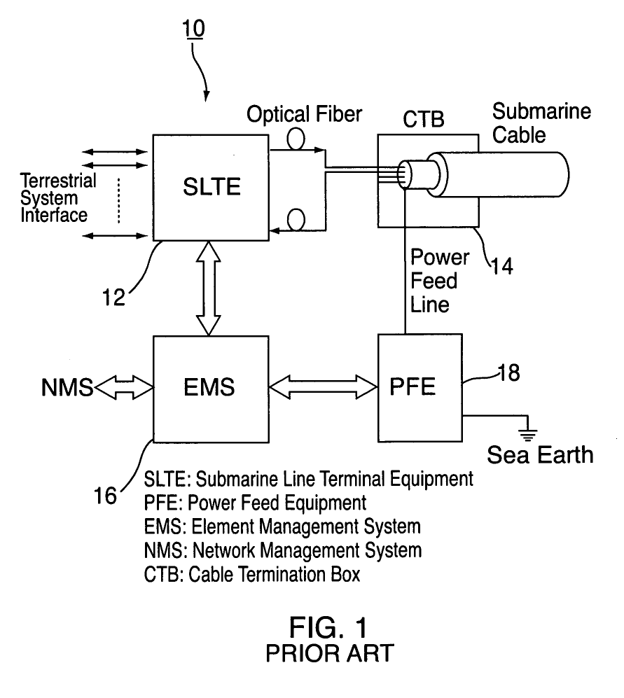

FIG. 2 shows a functional block diagram of a cable station constructed in accordance with the present invention.

FIG. 3 shows a simplified block diagram of an exemplary wavelength division multiplexed (WDM) transmission system in which the cable station shown in FIG. 2 may be employed.

FIG. 4 shows a block diagram of one embodiment of an optical interface device employed in the present invention.

### DETAILED DESCRIPTION

The present inventors have recognized that much of the functionality of a conventional, highly specialized SLTE can be performed by conventional optical transmission equipment of the type that is generally employed in a terrestrial POP such as a central office, switching station, or other network access point. That is, the terrestrial optical transmission equipment performs any necessary optical-to-electrical conversion, FEC processing, electrical-to-optical conversion, and optical multiplexing. The terrestrial optical transmission equipment may also perform optical amplification, optical monitoring that is designed for the terrestrial optical network, and network protection. Examples of terrestrial optical equipment that are currently available and which may be used in connection with the present invention include, but are not limited to, the Nortel LH1600 and LH4000, Siemens MTS 2, Cisco 15808 and the Ciena CoreStream long-haul transport products. The terrestrial optical equipment may also be a network router in which Internet routing is accomplished as well the requisite optical functionality. Moreover, the terrestrial optical equipment that is employed may conform to a variety of different protocol standards, such SONET/SDH ATM and Gigabit Ethernet, for example.

The remaining functionality of the SLTE can be performed by an interface device that provides the signal conditioning necessary to transmit the traffic over an undersea optical transmission cable. One example of suitable interface device is disclosed in U.S. application Ser. No. 10/621,028, which is hereby incorporated by reference in its entirety.

As discussed in the aforementioned reference, the optical interface device disclosed therein receives the optical signals from terrestrial optical transmission equipment such as a SONET/SDH transmission terminal either as individual wavelengths on separate fibers or as a WDM signal on a single fiber. The interface device provides the optical layer signal conditioning that is not provided by the SONET/SDH terminals, but which is necessary to transmit the optical signals over the undersea transmission path. The signal conditioning that is provided may include, but is not limited to, gain equalization, bulk dispersion compensation, optical amplification, multiplexing, Raman amplification, dispersion slope compensation, polarization mode dispersion (PMD) compensation, performance monitoring, signal load balancing (e.g., dummy channel insertion), or any combination thereof. The optical interface device may also include line monitoring equipment such as a COTDR arrangement, an autocorrelation arrangement, or other techniques that uses in-band or out-of band probe signals to determine the status and health of the transmission path. Additionally, the optical interface device may supply pump power to the transmission path so that Raman amplification can be imparted to the optical signals,

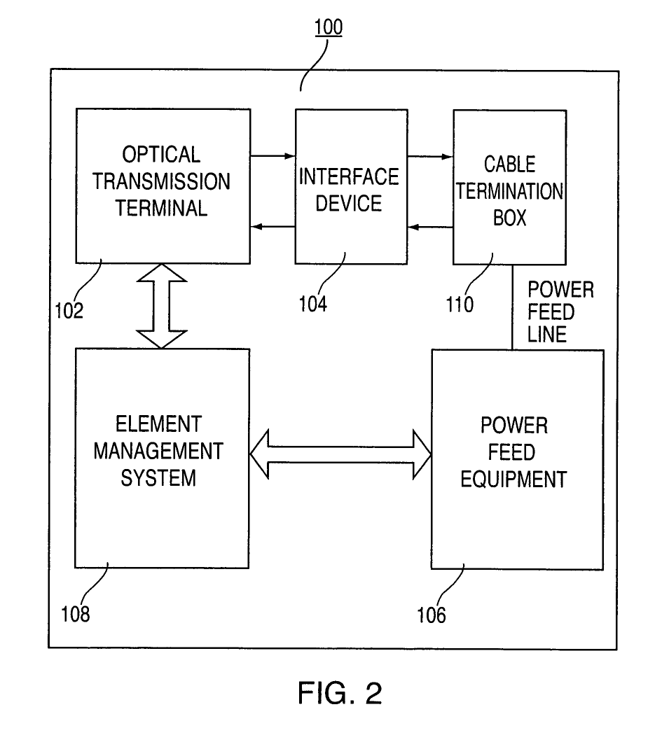

In one embodiment of the invention, the terrestrial equipment and the interface device are located in the cable station of the undersea optical transmission system. FIG. 2 shows a functional block diagram of a cable station constructed in accordance with the present invention. Cable station 100 includes optical transmission equipment 102, interface device 104, power feed equipment (PFE) 106, element management system (EMS) 108 and a cable termination box (CTB) 110.

The available floor space in a cable station is typically kept to a minimum because of its proximity to seashore. Accordingly, in some embodiments of the invention it may be advantageous to place the optical transmission terminal 102 in the POP, thereby reducing the amount of floor space that is required. In this case the transmission equipment 102 and the interface device 104 are remotely located with respect to one another. In yet another embodiment of the invention, the required amount of floor space in the cable station can be further reduced by placing both the transmission equipment 102 and the interface device 104 in the POP.

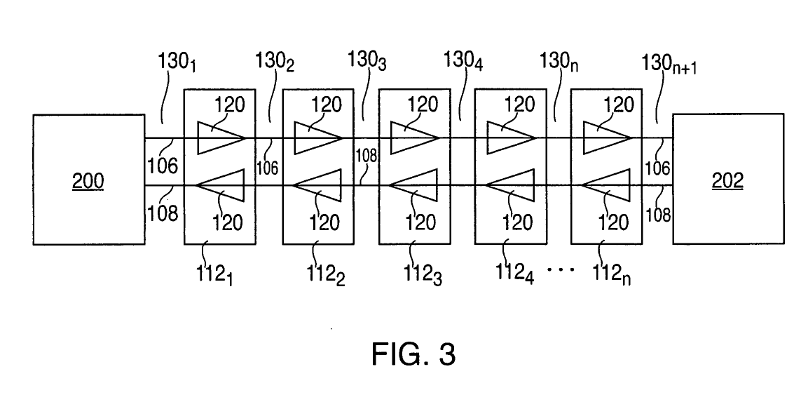

FIG. 3 shows a simplified block diagram of an exemplary wavelength division multiplexed (WDM) transmission system in which the cable stations shown in FIG. 2 may be employed. The transmission system serves to transmit a plurality of optical channels over a pair of unidirectional optical fibers 106 and 108 between cable stations 200 and 202. Cable stations 200 and 202 are of the type depicted in FIG. 2. The transmission path is segmented into transmission spans or links 130₁, 130₂, 130₃, . . . 130ₙ₊₁. The transmission spans 130, which are concatenated by repeaters 112₁, 112₂, . . . 112ₙ can range from 40 to 120 km in length, or even longer if Raman amplification is employed. The repeaters include optical amplifiers 120 that connect each of the spans 130.

While FIG. 3 shows a repeatered undersea optical transmission system, those of ordinary skill in the art will recognize that the inventive cable stations may also be employed in unrepeatered systems. Moreover, the invention is not limited to point-to-point network architectures such as shown in FIG. 3 but more generally may encompass more complex architectures such as those employing branching units, optical mesh networks, and ring networks, for example.

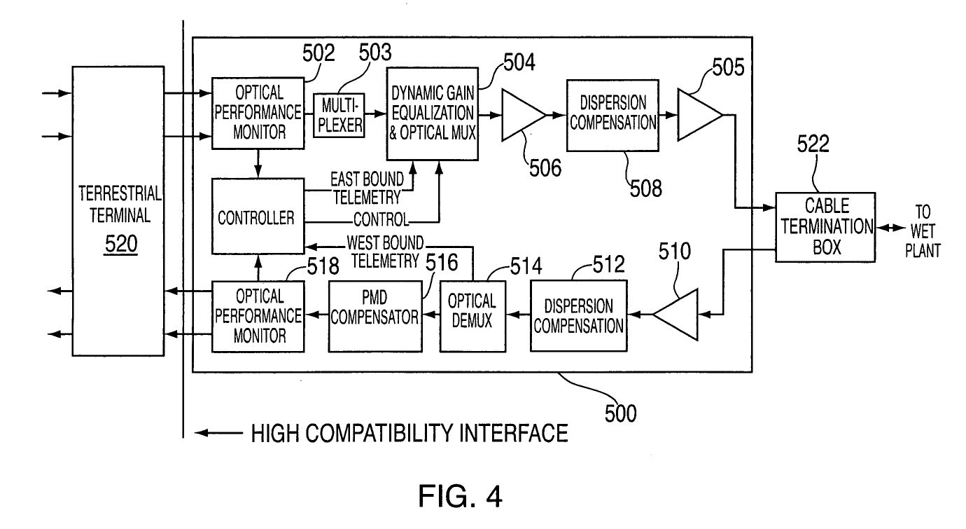

FIG. 4 shows a block diagram of one embodiment of the optical interface device 500 shown in U.S. application Ser. No. 10/621,028. Also seen in FIG. 4 is optical transmission terminal 520 and cable termination box 522. The optical signal received from the terminal 520 is monitored for optical performance by optical performance monitor 502, multiplexed by multiplexer 503, then power equalized by polarization multiplexer 504, optically amplified by amplifier 506, passed through a dispersion compensation device 508 such as a dispersion compensating fiber or a grating-based dispersion compensation device, and optically amplified by amplifier 505, after which the optical signal is ready to traverse the undersea optical transmission path. Likewise, the optical signal received by the interface device 500 from the undersea optical transmission path is optically amplified by amplifier 510, passed through a dispersion compensation device 512, optically demultiplexed by demultiplexer 514, passed through a polarization mode dispersion (PMD) compensator 516, and monitored for performance by optical performance monitor 518.

The optical performance monitors 502 and 518 ensure that appropriate signal quality is maintained. The optical performance monitors 502 and 518 may measure the OSNR, Q-factor, or BER of the optical signal. In operation, a tap or other device directs a small portion of the optical signal to an optical amplifier, filter, and a receiver for converting the optical signal to an electrical signal. A dual channel CDR with an adjustable decision threshold and phase is used to determine the error performance of the data signal. The optical performance information determined by the performance monitor 520 may be used as feedback to control the gain equalizer 504 or the PMD compensator 516.

Although various embodiments are specifically illustrated and described herein, it will be appreciated that modifications and variations of the present invention are covered by the above teachings and are within the purview of the appended claims without departing from the spirit and intended scope of the invention. For example, while the invention has been discussed in terms of an undersea optical transmission system, those of ordinary skill in art will recognize that the invention is equally applicable to a land-based optical transmission system in which the electrical power for the repeaters is supplied from the cable stations. Such a transmission system may be advantageously employed, for example, in a remote location where it would otherwise be difficult to power and access the repeaters.

1. A land-based cable station for an undersea optical transmission system, comprising:
submarine line terminal equipment (SLTE) for processing terrestrial traffic received from an external source;
power feed equipment for supplying electrical power to active undersea components of the transmission system;
an element management system for configuring and obtaining status information from the transmission system;
a cable termination box in which an undersea cable terminates; and
wherein said SLTE includes:
terrestrial optical transmission equipment receiving the terrestrial traffic and generating optical signals in response thereto; and
an interface device providing signal conditioning to the optical signals received from the terrestrial optical transmission equipment so that the optical signals are suitable for transmission through the undersea optical transmission system.

2. The cable station of claim 1 wherein said terrestrial optical equipment is a SONET/SDH terminal.

3. The cable station of claim 1 wherein said terrestrial optical terminal is an ATM terminal.

4. The cable station of claim 1 wherein said terrestrial optical terminal is a Gigabit Ethernet terminal.

5. The cable station of claim 1 wherein said undersea optical transmission system is a WDM transmission system.

6. The cable station of claim 1 wherein the interface device is configured to perform at least one signal conditioning process selected from the group consisting of gain equalization, bulk dispersion compensation, optical amplification, Raman amplification, dispersion slope compensation, PMD compensation, load balancing, and performance monitoring.

7. The cable station of claim 1 wherein the external source from which the terrestrial traffic is received is a terrestrial point-of-presence.

8. The cable station of claim 1 wherein said interface device includes line monitoring equipment.

9. The cable station of claim 8 wherein line monitoring equipment is a COTDR arrangement.

10. The cable station of claim 1 wherein said interface device includes means for supplying pump power to impart Raman amplification to the optical signals.

11. An undersea optical transmission system, comprising:
at least first and second cable stations remotely located with respect to one another;
an undersea optical transmission path optical coupling the first and second cable stations;
at least one optical repeater located along the optical transmission path;
wherein at least one of the first and second cable stations includes:
submarine line terminal equipment (SLTE) for processing terrestrial traffic received from an external source, said SLTE including terrestrial optical transmission equipment receiving the terrestrial traffic and generating optical signals in response thereto, and an interface device providing signal conditioning to the optical signals received from the terrestrial optical transmission equipment so that the optical signals are suitable for transmission through the undersea optical transmission path;
power feed equipment for supplying electrical power to the repeater;
an element management system for configuring and obtaining status information from the transmission system;
a cable termination box in which the undersea optical transmission path terminates.

12. The undersea optical transmission system of claim 11 wherein said terrestrial optical equipment is a SONET/SDH terminal.

13. The undersea optical transmission system of claim 11 wherein said terrestrial optical equipment is an ATM terminal.

14. The undersea optical transmission system of claim 11 wherein said terrestrial optical equipment is a Gigabit Ethernet terminal.

15. The undersea optical transmission system of claim 11 wherein said undersea optical transmission system is a WDM transmission system.

16. The undersea optical transmission system of claim 11 wherein the interface device is configured to perform at least one signal conditioning process selected from the group consisting of gain equalization, bulk dispersion compensation, optical amplification, Raman amplification, dispersion slope compensation, PMD compensation, load balancing, and performance monitoring.

17. The undersea optical transmission system of claim 11 wherein the external source from which the terrestrial traffic is received is a terrestrial point-of-presence.

18. The undersea optical transmission system of claim 11 wherein said interface device includes line monitoring equipment.

19. The undersea optical transmission system of claim 18 wherein line monitoring equipment is a COTDR arrangement.

20. The undersea optical transmission system of claim 11 wherein said interface device includes means for supplying pump power to impart Raman amplification to the optical signals.

21. The undersea optical transmission system of claim 11 wherein said optical repeater includes at least one rare-earth doped optical amplifier.

22. The undersea optical transmission system of claim 11 wherein said undersea optical transmission path is a WDM transmission path.

23. An undersea optical transmission system, comprising:
at least first and second cable stations remotely located with respect to one another;
an undersea optical transmission path optical coupling the first and second cable stations;
at least one optical repeater located along the optical transmission path;
terrestrial optical transmission equipment receiving terrestrial traffic and generating optical signals in response thereto
wherein at least one of the first and second cable stations includes:
an interface device providing signal conditioning to the optical signals received from the terrestrial optical transmission equipment so that the optical signals are suitable for transmission through the undersea optical transmission path;
power feed equipment for supplying electrical power to the repeater;
an element management system for configuring and obtaining status information from the transmission system;
a cable termination box in which the undersea optical transmission path terminates.

24. The undersea optical transmission system of claim 23 wherein said terrestrial optical equipment is a SONET/SDH terminal.

25. The undersea optical transmission system of claim 23 wherein said terrestrial optical equipment is an ATM terminal.

26. The undersea optical transmission system of claim 23 wherein said terrestrial optical equipment is a Gigabit Ethernet terminal.

27. The undersea optical transmission system of claim 23 wherein said undersea optical transmission system is a WDM transmission system.

28. The undersea optical transmission system of claim 23 wherein the interface device is configured to perform at least one signal conditioning process selected from the group consisting of gain equalization, bulk dispersion compensation, optical amplification, Raman amplification, dispersion slope compensation, PMD compensation, load balancing, and performance monitoring.

29. The undersea optical transmission system of claim 23 wherein the external source from which the terrestrial traffic is received is a terrestrial point-of-presence.

30. The undersea optical transmission system of claim 23 wherein said interface device includes line monitoring equipment.

31. The undersea optical transmission system of claim 30 wherein line monitoring equipment is a COTDR arrangement.

32. The undersea optical transmission system of claim 23 wherein said interface device includes means for supplying pump power to impart Raman amplification to the optical signals.

33. The undersea optical transmission system of claim 23 wherein said optical repeater includes at least one rare-earth doped optical amplifier.

34. The undersea optical transmission system of claim 23 wherein said undersea optical transmission path is a WDM transmission path.

35. A land-based cable station for a terrestrial optical transmission system, comprising:
line terminal equipment (LTE) for processing terrestrial traffic received from an external source;
power feed equipment for supplying electrical power to active components of the transmission system;
an element management system for configuring and obtaining status information from the transmission system;
a cable termination box in which a transmission cable terminates; and
wherein said LTE includes:
terrestrial optical transmission equipment receiving the terrestrial traffic and generating optical signals in response thereto; and
an interface device providing signal conditioning to the optical signals received from the optical transmission equipment so that the optical signals are suitable for transmission through the optical transmission system.

36. The cable station of claim 35 wherein said terrestrial optical equipment is a SONET/SDH terminal.

37. The cable station of claim 35 wherein said terrestrial optical equipment is an ATM terminal.

38. The cable station of claim 35 wherein said terrestrial optical equipment is a Gigabit Ethernet terminal.

39. The cable station of claim 35 wherein said optical transmission system is a WDM transmission system.

40. The cable station of claim 35 wherein the interface device is configured to perform at least one signal process selected from the group consisting of gain equalization, bulk dispersion compensation, optical amplification, Raman amplification, dispersion slope compensation, PMD compensation, load balancing, and performance monitoring.

41. The cable station of claim 35 wherein the external source from which the terrestrial traffic is received is a terrestrial point-of-presence.

42. The cable station of claim 35 wherein said interface device includes line monitoring equipment.

43. The cable station of claim 42 wherein line monitoring equipment is a COTDR arrangement.

44. The cable station of claim 35 wherein said interface device includes means for supplying pump power to impart Raman amplification to the optical signals.

45. The cable station of claim 1 wherein said terrestrial optical equipment is an IP-based router.

46. The cable station of claim 1 wherein the external source from which the terrestrial traffic is received is a remotely located cable station.
